(19) United States
(12) Patent Application Publication
(10) Pub. No.: US 2025/0225407 A1
(43) Pub. Date: Jul. 10, 2025

(54) VERTICAL FEDERATED LEARNING METHOD BASED ON VARIATIONAL AUTOENCODER AND DATA ENHANCEMENT AND SYSTEM THEREOF

(71) Applicant: Hangzhou Dianzi University, Hangzhou (CN)

(72) Inventors: Meiting XUE, Hangzhou (CN); Li ZHOU, Hangzhou (CN); Yan ZENG, Hangzhou (CN); Jilin ZHANG, Hangzhou (CN); Yukun SHI, Hangzhou (CN); Kehan HE, Hangzhou (CN)

(21) Appl. No.: 18/967,361

(22) Filed: Dec. 3, 2024

(30) Foreign Application Priority Data
Jan. 10, 2024 (CN) 202410032784.X

(51) Int. Cl. G06N 3/098; G06N 3/0455

(52) U.S. Cl. CPC G06N 3/098; G06N 3/0455

(57) ABSTRACT

A vertical federated learning method based on a variational autoencoder and data enhancement and a system thereof are provided. The method includes: first, obtaining, by a participant, aligned data belonging to a same sample space in different participant data through vertical federated data alignment; second, locally initializing, by the participant, parameters of the variational autoencoder, and inputting, by the participant, the aligned data into a local encoder to obtain and send a latent space high-order feature representation vector group to other participants; thereafter, constructing a total update loss of a variational autoencoder model, and updating a local variational autoencoder model; finally, generating, by the variational autoencoder model of the participant, auxiliary data according to a local data input, and using, by the participant, original aligned data and the auxiliary data as aligned data to perform a vertical federated downstream task.

### CROSS-REFERENCE TO RELATED APPLICATION

This patent application claims the benefit and priority of Chinese Patent Application No. 202410032784.X filed with the China National Intellectual Property Administration on Jan. 10, 2024, the disclosure of which is incorporated by reference herein in its entirety as part of the present disclosure.

### TECHNICAL FIELD

The present disclosure belongs to the field of data enhancement, and in particular to a vertical federated learning method based on a variational autoencoder and data enhancement and a system thereof.

### BACKGROUND

With the popularity of the Internet and intelligent devices, a lot of data will be generated when they are used every day. If big data and artificial intelligence technology are used to mine and analyze these data, these data will have a great value. However, the traditional centralized machine learning technology requires that the data be uploaded to the central server for training, which involves issues such as communication, privacy, and security. Therefore, a new method is urgently needed to break through this dilemma.

Federated learning is a new method proposed to replace traditional centralized learning, which enables each data holder to cooperate with other data holders to train a globally shared global model through privacy protection without uploading local data to the server for centralized training. Vertical federated learning is a federated learning method, which is suitable for scenes where data sets of a plurality of participants have the same sample ID but different feature. The sample ID here refers to the set or range of identifiers of samples. Each sample has a unique identifier which is used to distinguish different samples. For example, the data sets owned by a bank and an e-commerce company in a certain region all contain residents in this region. The sample ID spaces may overlap, but the data features are completely different. The data from the bank describes the income and expenditure behavior and capital status of users, while the e-commerce company keeps the browsing and purchasing records of various commodities from users. The two companies can use vertical federated learning to jointly train a prediction model for a user to buy goods.

Because the data between different participants cannot be shared, there is no guarantee that there is a certain amount of data in the same sample ID space among participants, which will seriously hinder the convergence of the vertical federated learning model and result in performance degradation. Therefore, an effective vertical federated learning method is needed to solve the above problem.

A variational autoencoder is an effective generating model, the components of which include an encoder and a decoder. The encoder is responsible for mapping the input data to the distribution parameters of the latent space, and the decoder maps the samples sampled from a latent layer back to the original input space. Iterative optimization is used to learn the optimal coding-decoding method. In each iteration, the output after “encoding-decoding” is compared with the initial data, and the weight of the network is updated by back propagation. In recent years, due to its strong feature extraction and data compression capabilities, the variational autoencoder has been widely used in the fields such as image processing, data dimensionality reduction, and anomaly detection.

### SUMMARY

To address the shortcomings of the prior art, the present disclosure designs and realizes a vertical federated learning method based on a variational autoencoder and data enhancement and a system thereof.

By utilizing the strong feature extraction and data compression capabilities of the variational autoencoder, the present disclosure enables the variational autoencoder to learn the local data latent space representation of the participants. Through the shared learning of the latent space high-order feature representation vector groups among participants, each participant can extract the feature representations of other participants. Through the learning among different features, the local variational autoencoders can be better trained, so that participants can generate high-quality data. After the new data sets generated by the participants are aligned, auxiliary data sets are generated for subsequent vertical federated learning training, so as to accelerate the convergence of the vertical federated learning model and optimize the model performance, and solve the problem that the global model performance is poor during federated learning due to a small number of aligned samples.

A vertical federated learning method based on a variational autoencoder and data enhancement includes:
S1, obtaining, by a participant, aligned data {X₁, . . . , X_{N}} belonging to a same sample space in different participant data through vertical federated data alignment;
S2, locally initializing, by the participant, parameters of the variational autoencoder, where encoder parameters are {E₁, . . . , E_{M}} and generator parameters are {D₁, . . . , D_{M}};
S3, inputting, by the participant, the aligned data into a local encoder to obtain a latent space high-order feature representation vector group {Z₁, . . . , Z_{M}} and sending the latent space high-order feature representation vector group to other participants;
S4, constructing a total update loss of a variational autoencoder model, and updating a local variational autoencoder model;
S5, repeating Step S3 to Step S4 until a predetermined number of iterations are completed;
S6, generating, by the variational autoencoder model of the participant, auxiliary data according to a local data input, and using, by the participant, original aligned data and the auxiliary data together as aligned data to carry out a vertical federated downstream task.

In Step S1, a specific operation of the vertical federated data alignment includes: with different participants having different data sample spaces, implementing data alignment by making two different sample features actually representing a same entity correspond to each other; and where {X₁, . . . , X_{N}} indicates that there are N pieces of data that are aligned in a two-party data set.

In Step S2, for the encoder parameters {E₁, . . . , E_{M}} and the generator parameters {D₁, . . . , D_{M}}, Eᵢ and Dᵢ denote encoder parameters and generator parameters of an i-th participant, respectively, and M represents a number of participants.

In Step S3, for the latent space high-order feature representation vector group {z₁, . . . , z_{M}}, Zᵢ denotes a latent space high-order feature representation vector group of an aligned data of an i-th participant output by an encoder of the i-th participant.

In Step S4, a specific operation of constructing the total update loss of the variational autoencoder model comprises: calculating, by the participant, a regularization loss and a reconstruction loss corresponding to the local latent space high-order feature representation vector group, and then, calculating a pairing loss and a contrast loss according to the latent space high-order feature representation vector groups of other participants, and adding four different losses in different weight ratios as the total update loss of the variational autoencoder model.

The purpose of the regularization loss is to ensure that the latent space learned from local data has a good structure. KL divergence is used to measure the difference between the distribution in the latent space and the standard normal distribution. The purpose of the reconstruction loss is to ensure the ability to generate data by the model, that is, the ability to reconstruct the input data from the latent space, and the ability of the reconstruction is measured by the cross-entropy loss. The purpose of the pairing loss is to ensure that the latent space vector representations of different features of the same sample can be as close as possible, and a mean square error is used to measure the pairing of features. The purpose of the pairing loss is to ensure that the latent space vector representations of different features of the same sample can be as close as possible, and a mean square error is used to measure the pairing of features. The purpose of contrast loss is to ensure that the vector representations of the latent high-order feature representations of the same sample are as close as possible and are as far away from the vector representations of the latent high-order feature representations of other samples as possible.

An embodiment of the present disclosure provides a vertical federated learning system based on a variational autoencoder and data enhancement, where the system includes a data pre-training module, a generating model training module and a data updating module;
the data pre-training module is configured to carry out the vertical federated data alignment on local data sets for participants participating in federated learning to obtain an original data set, and initialize a variational autoencoder;
the generating model training module is configured to train variational autoencoder models of participants participating in federated learning through a processed original data set, and carry out a joint training according to a training loss of each participant;
the data updating module is configured to generate new data through the participants, integrate processed original training set with newly generated data to construct a new data set for a federated learning training task.

The present disclosure has the following advantages:

An optimization solution of vertical federated learning by using aligned data as data enhancement is put forward first in the method, so that participants can generate high-quality data, thus accelerating the convergence of the vertical federated learning model and optimizing the model performance.

In the case of less aligned data, the method can effectively improve the accuracy of a vertical federated learning model in regression and classification tasks.

The accuracy of the vertical federated learning model can be improved when a plurality of data sets and a plurality of data are aligned.

### BRIEF DESCRIPTION OF THE DRAWINGS

FIG. 1 is a flow chart of a method according to the present disclosure.

FIG. 2 is a schematic diagram of the effect on an Adult data set of federated learning according to the embodiment of the present disclosure.

### DETAILED DESCRIPTION OF THE EMBODIMENTS

The present disclosure will be further explained in conjunction with the attached drawings and specific implementation steps.

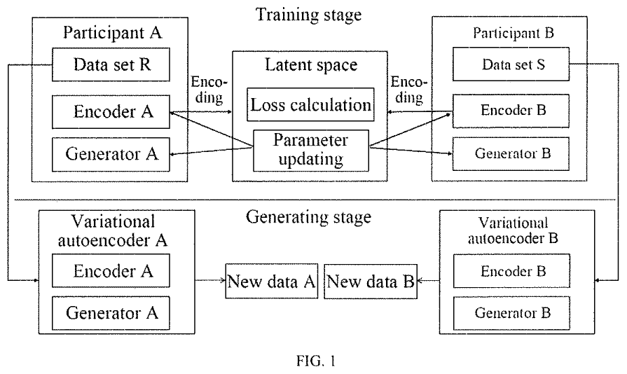

A vertical federated learning method based on the variational autoencoder and data enhancement is shown as a flow chart of this solution in FIG. 1, and includes steps S1-S6.
S1: in this example, an Adult data set is taken as a participant data set, data with six feature data is allocated to participant A as a data set R, and data with eight feature data (including tags) is allocated to participant B as a data set S. The allocating method determines that the participant A and the participant B have a same sample space {X₁, . . . , X_{N}}.
S2: encoders and generators are initialized. The encoders and the generators of all participants initialize a model network with same model parameters. An encoder network layer has a linear layer and a ReLU activation function, which are used to gradually reduce a dimension of input data. An output layer has two linear layers, which are used to output mean and variance of a latent space and calculate a corresponding latent space high-order feature representation vector. A generator network layer has a linear layer and a ReLU activation function, and finally a final result of the model is output by the linear layer.
S3: a participant inputs aligned data into a local encoder to obtain a latent space high-order feature representation vector group {Z₁, . . . , Z_{M}} and sends the latent space high-order feature representation vector group to other participants, and waits for other participant to send a latent space high-order feature representation vector group of this round.
S4: the participant calculates a regularization loss and a reconstruction loss corresponding to a local latent space high-order feature representation vector group, where a formula of calculating the regularization loss is as follows:

$${L}^{KL} = E [ log {q}_{ϕ} ( z \backslash x ) - log P ( z ) ]$$

Further, the regularization loss is calculated by KL divergence, and a specific calculation result is a regularization term of similarity measure between posterior distribution and hypothetical prior distribution. The posterior distribution is actually an encoder to be trained, which is equivalent to mapping an observation data x to a point on a standard normal distribution, that is to say, mapping a distribution of the observation data to a certain distribution. In this way, after training a whole variational autoencoder, the standard normal distribution is sampled in turn to be mapped to generated data. E represents an expectation, z˜Enc(x)=q_{ϕ}(z\x) is a mapping function of an encoder network, P(z) is a normal distribution, and z is a latent space high-order feature representation vector output by the encoder.

A formula of calculating the reconstruction loss is as follows:

$${L}^{Recon} = {E}_{{q}_{ϕ} ( z / x )} [ log {p}_{Ψ} ( x \backslash z ) ]$$

Further, x˜Dec(z)=p_{Ψ}(x\z) is a mapping function of a decoder network. z is the latent space high-order feature representation vector output by the encoder. The reconstruction loss is an index to measure a reconstruction ability of a decoder, and a calculation method is to compare an expected value of a given Gaussian distribution that follows a real distribution with observed data of the real distribution. A gap between generated data and sample data is minimized.

Thereafter, a pairing loss and a contrast loss are calculated according to the latent space high-order feature representation vector group of other participant.

A formula of calculating the pairing loss is as follows:

$${L}^{Match} = {E}_{z ∼ {p}_{z}} [ {‖ {z}_{1} - {z}_{2} ‖}^{2} ]$$

Because different input feature pairs of the same sample originate from the same sample, high-order implicit feature representations mapped by the encoder should be semantically similar, that is, they should be close in the shared latent space. Therefore, the feature pairing loss is defined as an Euclidean distance of the high-order feature representation vector group in the shared latent space, where ∥ ∥² is used to represent L2 norm between vectors. z₁ and z₂ denote latent space high-order feature representation vectors of participants, respectively.

A formula of calculating the contrast loss is as follows. A loss function of a positive sample pair (zᵢ_{^{a}}, zᵢ_{^{b}}) can be expressed as:

$${L}_{{z}_{i} a , {z}_{{i}^{b}}}^{Contra} = - log \frac{exp ( sim ( {z}_{i} a , {z}_{{i}^{b}} ) / τ )}{{\sum }_{{i}^{ab} = 1}^{2 N} {[ {i}^{ab} \neq {i}^{a} ]}_{} exp ( sim ( {z}_{i} a , {z}_{{i}^{ab}} ) / τ )}$$

The contrast loss can measure feature pairing between different samples and distinguish different features of the same sample from features of different samples in the latent space. sim(u, v)=u^{T}v∥u∥∥v∥ denotes a cosine similarity between two vectors; τ>0 is a temperature normalization factor. An indicator vector [symbol] _{[n≠m]}∈{0,1} takes a value of 1 if and only if n≠m; i^{ab}∈{1, 2, . . . , 2N} denotes a vector index in the latent space. A final contrast learning loss is calculated by adding loss functions of all positive sample pairs (zᵢ_{^{a}}, zᵢ_{^{b}}) and (zᵢ_{^{b}}, zᵢ_{^{a}}) (N pairs in total), and its mathematical expression is as follows:

$${L}^{Contra} = \frac{1}{2 N} {\sum }_{{i}^{a} = 1}^{N} {\sum }_{{i}^{b} = 1}^{N} {L}_{{z}_{i} a , {z}_{{i}^{b}}}^{Contra} + {L}_{{z}_{{i}^{b}} , {z}_{i} a}^{Contra}$$

All losses are added according to corresponding weight ratios α, β, γ and δ, that is, Loss=αL^{KL}+βL^{Recon}+γL^{Match}+δL^{Contra}, and parameters of the local variational autoencoder model are updated by using an adaptive learning rate gradient descent algorithm (Adam).
S5: Step S3 to Step S4 are repeated until a predetermined number of iterations are completed. A training of local models of participant A and participant B including an encoder and a generator is completed.
S6: A participant variational autoencoder model generates auxiliary data according to a local aligned data input, and the participant uses the original aligned data and the auxiliary data together as an aligned data to carry out a vertical federated downstream task.

On the other hand, the present disclosure provides a vertical federated learning system based on variational autoencoders and data enhancement, wherein the system includes a data pre-training module, a generating model training module and a data updating module.

The data pre-training module is configured to carry out vertical federated data alignment on local data sets for participants participating in federated learning to obtain an original data set, and initialize variational autoencoders.

The generating model training module is configured to train a variational autoencoder model of each participant participating in federated learning through a processed original data set, and carry out joint training according to a training loss of each participant.

The data updating module is configured to generate new data through participants, integrate processed original training set with newly generated data, and construct a new data set for a federated learning training task.

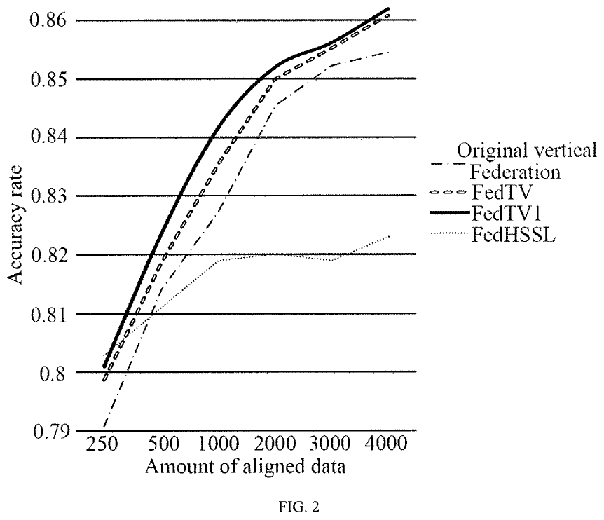

FIG. 2 shows the performance of different amounts of aligned data in the Adult data set. The original vertical federation does not carry out any data enhancement processing with poor performance. FedTV (participants only use the regularization loss and the reconstruction loss) expands the data set because of the addition of generated data, and optimizes the accuracy of the vertical federated learning system to some extent. FedHSSL (Federated Hybrid Self-supervised Learning Framework) is not as effective as the original vertical federated learning because there is no misaligned data for self-supervised learning. FedTV1 (the participants use the regularization loss, the reconstruction loss, the pairing loss and the contrast loss) generates high-quality generated data, which better optimizes the accuracy of the vertical federated learning system.

From the results, the method of the present disclosure obviously improves the test accuracy of the vertical federated learning system in the case of limited aligned data, improves the robustness of the system, and has a very broad application prospect.

What is claimed is:

1. A vertical federated learning method based on a variational autoencoder and data enhancement, comprising:
S1: obtaining, by a participant, aligned data {X₁, . . . , X_{N}} belonging to a same sample space in different participant data through vertical federated data alignment;
S2: locally initializing, by the participant, parameters of the variational autoencoder, wherein encoder parameters are {E₁, . . . , E_{M}} and generator parameters are {D₁, . . . , D_{M}}, wherein M denotes a number of the participants;
S3: inputting, by the participant, the aligned data into a local encoder to obtain a latent space high-order feature representation vector group {Z₁, . . . , Z_{M}} and sending the latent space high-order feature representation vector group to other participants;
S4: constructing a total update loss of a variational autoencoder model, and updating a local variational autoencoder model;
S5: repeating Step S3 to Step S4 until a predetermined number of iterations are completed; and
S6: generating, by the variational autoencoder model of the participant, auxiliary data according to a local data input, and using, by the participant, original aligned data and the auxiliary data together as aligned data to carry out a vertical federated downstream task.

2. The vertical federated learning method based on the variational autoencoder and data enhancement according to claim 1, wherein in Step S1, a specific operation of the vertical federated data alignment comprises: with different participants having different data sample spaces, implementing data alignment by making two different sample features representing a same entity correspond to each other; and wherein {X₁, . . . , X_{N}} indicates that there are N pieces of data that are aligned in a two-party data set.

3. The vertical federated learning method based on the variational autoencoder and data enhancement according to claim 2, wherein in Step S4, a specific operation of constructing the total update loss of the variational autoencoder model comprises: calculating, by the participant, a regularization loss and a reconstruction loss corresponding to the local latent space high-order feature representation vector group, and then calculating a pairing loss and a contrast loss according to the latent space high-order feature representation vector groups of other participants, and adding four different losses in different weight ratios as the total update loss of the variational autoencoder model.

4. A vertical federated learning system based on a variational autoencoder and data enhancement to implement the method according to any one of claim 1, wherein the system comprises a data pre-training module, a generating model training module and a data updating module;
the data pre-training module is configured to carry out the vertical federated data alignment on local data sets for participants participating in federated learning to obtain an original data set, and initialize a variational autoencoder;
the generating model training module is configured to train variational autoencoder models of the participants participating in federated learning through a processed original data set, and carry out a joint training according to a training loss of each participant;
the data updating module is configured to generate new data through the participants, integrate processed original training set with newly generated data to construct a new data set for a federated learning training task.
